(19) United States
(12) Patent Application Publication
(10) Pub. No.: US 2016/0328128 A1
(43) Pub. Date: Nov. 10, 2016

(54) PULLING GRAPHICAL USER INTERFACE WIDGETS FOR COMMUNICATION DEVICES

(71) Applicant: Avaya Inc., Santa Clara, CA (US)

(72) Inventors: Rifaat Shekh-Yusef, Belleville (CA); Gordon R. Brunson, Broomfield, CO (US); Joel M. Ezell, Broomfield, CO (US); Milos Pujic, Belleville (CA)

(21) Appl. No.: 14/721,783

(22) Filed: May 26, 2015

Related U.S. Application Data
(63) Continuation-in-part of application No. 14/707,839, filed on May 8, 2015, now abandoned.

(51) Int. Cl. G06F 3/0484; G06F 3/01; G06F 3/0482; G06F 3/16; G06F 17/22; G06F 3/0481

(52) U.S. Cl. CPC G06F 3/04845; G06F 17/2247; G06F 3/04817; G06F 3/0482; G06F 3/16; G06F 3/016

(57) ABSTRACT

A communication device gets a widget resource Uniform Resource Identifier (URI) from the network. The widget resource URI is used by the communication device to get a widget (i.e., a graphical user interface object) of a networked application that is displayed on the communication device. In response to getting the widget resource URI, the communication device downloads a context document from the widget resource URI. The context document defines the widget or a location of a widget document that defines the widget for use in the communication device. The communication device identifies an attachment point for the widget (i.e., a place to display the widget) that is associated with an activation of a device object (e.g., a window). The communication device determines that the attachment point is within a scope. In response to determining that attachment point is within the scope, the widget is displayed on the communication device.

### TECHNICAL FIELD

The systems and methods disclosed herein relate to communication devices and in particular to managing graphical elements of communication devices.

### BACKGROUND

Today, communication devices, such as telephones, are becoming increasingly complex. As more and more features are added, the complexity increases exponentially. As a result, it has become increasingly more difficult to continually support additional features. Even simple changes can cause long delays and difficulty in locating problems. The more complicated the software in the communication devices, the longer and more complex the development and testing process becomes. This results in increased costs and lower quality software.

### SUMMARY

Systems and methods are provided to solve these and other problems and disadvantages of the prior art. A communication device gets a widget resource Uniform Resource Identifier (URI) from the network. The widget resource URI is used by the communication device to get a widget (i.e., a graphical user interface object) of a networked application that is displayed on the communication device. In response to getting the widget resource URI, the communication device downloads a context document from the widget resource URI. The context document defines the widget or a location of a widget document that defines the widget for use in the communication device. The communication device identifies an attachment point for the widget (i.e., a place to display the widget) that is associated with an activation of a device object (e.g., a window). The communication device determines that the attachment point is within a scope. In response to determining that attachment point is within the scope, the widget is displayed on the communication device.

### BRIEF DESCRIPTION OF THE DRAWINGS

FIG. 1 is a block diagram of a first illustrative system for managing widgets on a communication device.

FIG. 2A is a diagram of context document and widget document for a communication device.

FIG. 2B is a diagram of context document and widget document for a communication device.

FIG. 3 is a flow diagram of a process for managing widgets on a communication device.

FIG. 4 is a flow diagram of a process for determining an attachment point for a scope of a widget.

### DETAILED DESCRIPTION

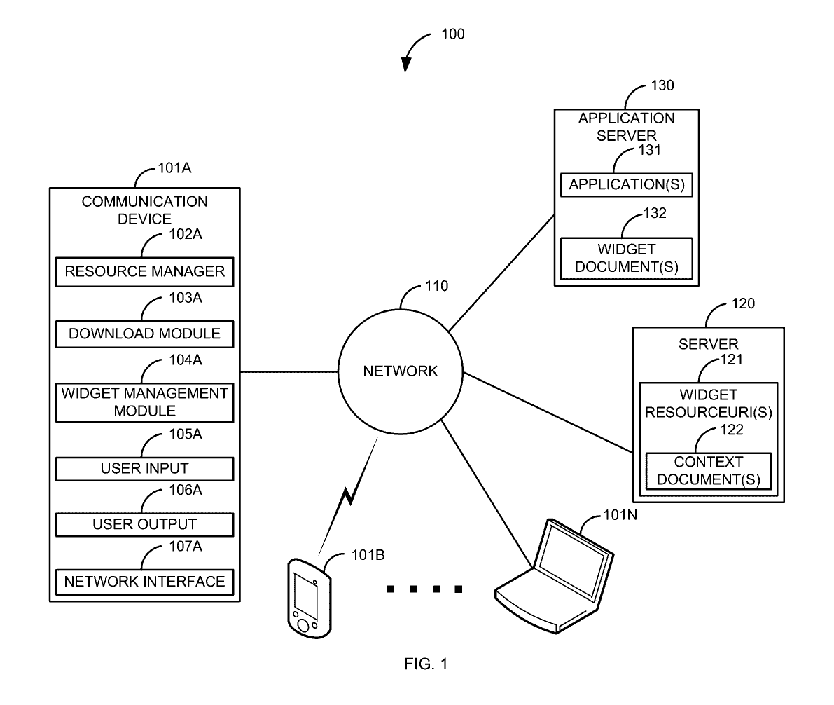

FIG. 1 is a block diagram of a first illustrative system 100 for managing widgets on a communication device 101. The first illustrative system 100 comprises communication devices 101A-101N, a network 110, a server 120, and an application server 130.

The communication device 101 can be or may include any device that can communicate on the network 110, such as a Personal Computer (PC), a telephone, a video system, a cellular telephone, a Personal Digital Assistant (PDA), a tablet device, a notebook device, a conference bridge, and the like. As shown in FIG. 1, any number of communication devices 101A-101N may be connected to the network 110, including only a single communication device 101.

The communication device 101A further comprises a resource manager 102A, a download module 103A, a widget management module 104A, a user input 105A, a user output 106A, and a network interface 107A. The communication devices 101B-101N are not shown comprising the elements 102-107. However, in some embodiments, the communication devices 101B-101N may also include the elements 102-107 or a subset of the elements 102-107.

The resource manager 102A can be or may include any hardware/software that can manage resources within the communication device 101. For example, the resource manager 102A may be a processor that controls various resources, such as memory and software within the communication device 101.

The download module 103A can be or may include any hardware/software that can download documents and/or software to the communication device 101A. The widget management module 104A can be or may include any hardware/software that can manage widgets for the communication device 101A. A widget is a graphical user interface object, such as a button, a menu, a menu bar, an icon, a tab, a text, a text field for entering text, a cursor, a window, and/or the like. The widget management module 104A manages when and how various widgets, for the various applications 131, are displayed on the communication device 101A.

The user input 105A can be or may include any hardware that allows a user to provide input to the communication device 101A, such as, a mouse, a trackball, a touch screen, a microphone, a keyboard, a key pad, a touch pad, and/or the like. The user output 106A can be or may include any hardware that provides output to a user, such as a visual display, a speaker, a vibrator, and/or the like.

The network interface 107A can be or may include any hardware that allows the communication device 101A to communicate with the network 110, such as an Ethernet Interface, a wireless interface, a WiFi interface, a fiber optic interface, a cellular interface, a wired interface, and/or the like. The network interface 107A may include multiple network interfaces 107A.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), Integrated Services Digital Network (ISDN), email protocols, text messaging protocols, Instant Messaging protocols, video protocols, Hyper Text Transfer Protocol (HTTP), and/or the like. Thus, the network 110 is an electronic communication network that allows for sending of messages via packets and/or circuit switched communications.

The server 120 can be or may include any server that can manage which applications 131 are supported by the communication devices 101A-101N, such as a proxy server, a Private Branch Exchange (PBX), a communications server, a communication manager, and/or the like. The server 120 can support a variety of protocols, such as Session Initiation Protocol (SIP), Hyper Text Transfer Protocol (HTTP), Java script, HTML, Java server pages, and/or the like.

The server 120 further comprises a set of widget resource Universal Resource Identifiers (URI) 121. Each communication device 101A-101N has a unique widget resource URI 121 that the communication device 101 uses to retrieve a context document 122. The widget resource URI 121 is an address/location that points to a context document 122 specific for the particular communication device 101.

A context document 122 is a document, such as an Extensible Markup Language (XML) document, text file, binary file, and/or the like that identifies which applications 131 are supported in the communication device 101. The context document 122 for each communication device 101 may be different depending upon the specific features supported/configured for the communication device 101. For example, the communication device 101A may support a call recording application 131 and a call forwarding application 131 while the communication device 101B may only support the call recording application 131.

The application server 130 can be or may include any server that can support applications 131, such as proxy server, a PBX, a communication server, a communication manager, and/or the like. The Application server 130 further comprises application(s) 131 and widget document(s) 132.

The application(s) 131 can comprise one or more network applications 131 that provide a variety of services, such as a call recording application, a call forwarding application, a call forking application, a Do Not Disturb (DND) application, a email application, an Instant Messaging application, a text messaging application, a voice mail application, a conferencing application, a billing application and/or the like. The application(s) 131 can be implemented in a variety of ways, such as in a Back-to-Back User Agent (B2BUA), as individual applications 131, and/or the like.

The widget document(s) 132 is a document that defines widgets for an application 131. The widget document(s) 132 may be in the same format as the context documents 122 or in a different format. The widget document(s) 132 may comprise individual widget documents 132 for each application 131. For example, if there were ten different applications 131, then there may be ten corresponding widget documents 132, one for each specific application 131. The widget document 132 may identify multiple widgets for an application 131. In one embodiment, the widget document 132 can define widgets for multiple applications 131.

In FIG. 1, the context document(s) 122 and the widget document(s) 132 are shown as separate documents on separate servers. However, in other embodiments, the context document(s) 122 and the widget document(s) 132 may be located on the same server. In some embodiments, the context document 122 and the widget documents 132 may be included in the same document. In another embodiment, the server 120 and the application server 130 may be a single server.

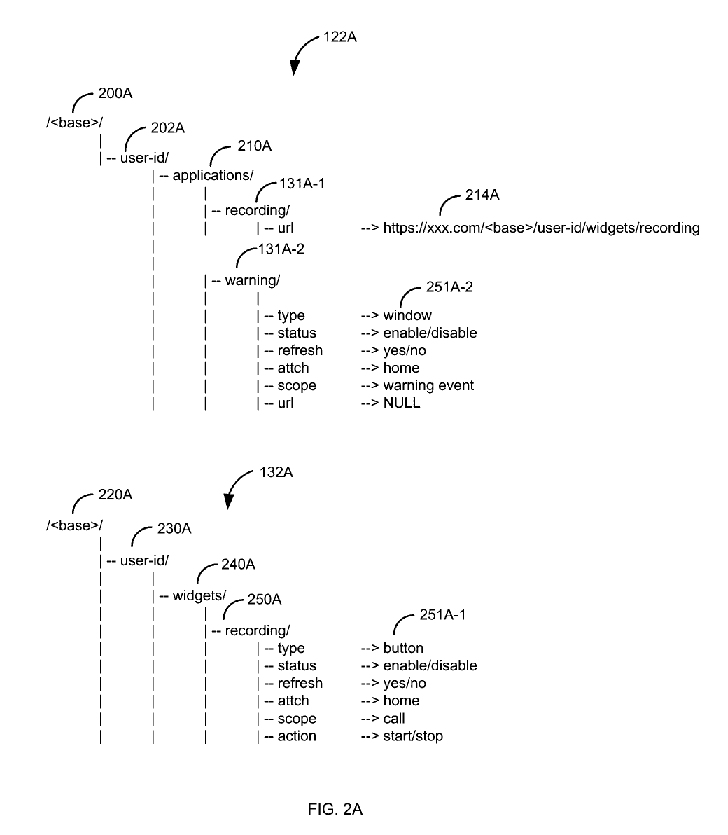

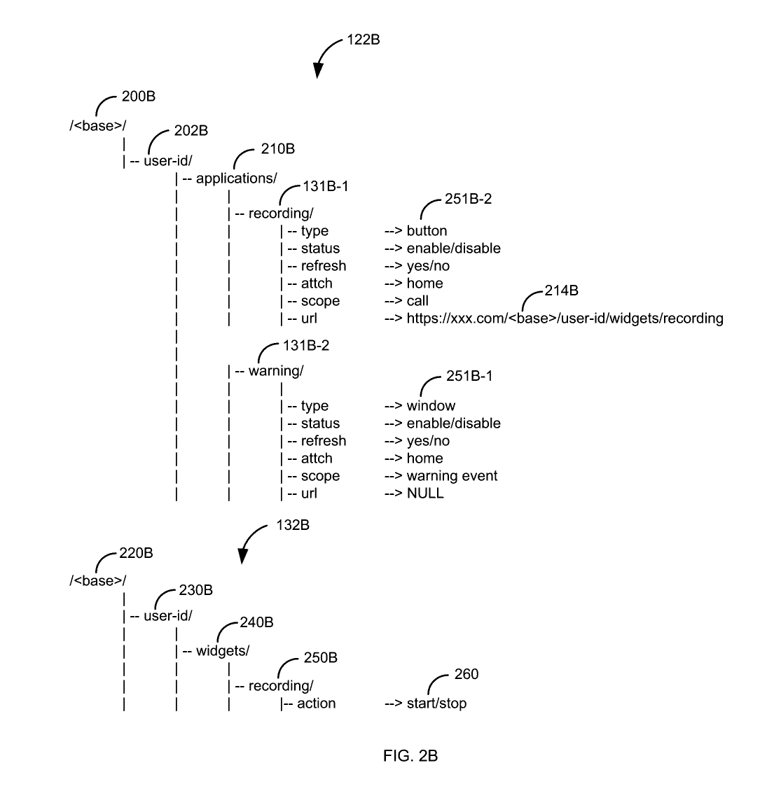

FIG. 2A is a diagram of context document 122A and widget document 132A for a communication device 101. The context document 122A is shown with a tree structure that defines a base level 200A, a user-id definition 202A, an application definition 210A, and two applications 131: a recording application 131A-1 and a warning application 131A-2. The communication device 101 downloads the context document 122A to identify the applications (131A-1 and 131A-2 in this example) that will be supported in the communication device 101. The user-id 220A is used to identify a specific user's applications 131.

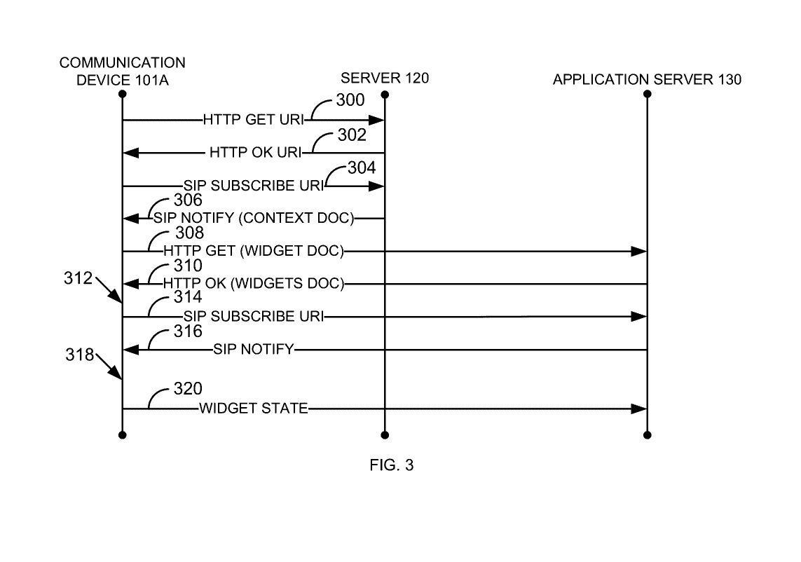

When the communication device 101 receives the context document 122A (as described in FIG. 3), the resource manager 102 parses the application definition 210A to identify the applications 131A-1 and 131A-2. In this example, the recording application 131A-1 and the warning application 131A-2 are defined differently to illustrate different ways that the context document 122A/widget document 132A can be defined.

For the recording application 131A-1, the resource manager 102 identifies the URL field 214A so the download module 103 can download the widget document 132A from the location of the URL field 214A. The URL field 214A is an address for the widget document 132A (which contains the associated widgets) for the recording application 131A-1. The widget management module 104 uses the widget document 132A to determine that the recording application 131A-1 has a single recording widget 250A. The functionality of the recording widget 250A is defined in the widget fields 251A-1. In this example, the recording widget 250A is a button (indicated by the type field) that can be enabled/disabled (indicated by the status field), and can be refreshed to indicated whether a call is being recorded or not (indicated by the refresh field). The recording widget 250A also has an attachment point of home. In this example, home refers to a home (or main) screen on the communication device 101. For example, the home screen is displayed on a telephone after the telephone has been initialized. The scope field is used to further determine when to display the recording widget 250A via the user output 106. In this example, the scope is when a call is active. For example, a call recording button will be displayed on the home window (attachment point) of the telephone (101) when a user initiates a call (within scope). The user can then select the recording button to record the call. When the user ends the call, the recording button is no longer within scope. The widget management module 104 then removes the recording button from the home screen and sends a copy of the recorded call to the user's email.

The recording widget 250A also includes an action field. The action field is used to convey state of the recording widget 250A. In this example, the recording widget 250A is a button that starts and stops a recording of a call. The action field is used by the communication device 101 to convey the current state of the recording button, such as if the button has been selected to start recording or to stop recording.

The widget for the warning application 131A-2 is defined without requiring a widget document 132A for the warning application 131A-2. In this example, the warning application 131A-2 has a single warning widget. The warning widget is a window, can be enabled/disabled, can be refreshed, has an attachment point of home, and a scope of warning event. However, the warning widget is defined in the context document 122A and has a URL field 214 of NULL (see widget field 251A-2) indicating that there is not corresponding widget document 132 for the warning application 131B.

The warning application 131A-2 does not have an action field like the recording application 131A-1. This is because the warning widget does not need to respond and send messages that provide a status (e.g., the like when the button of the recording application 131A-1 is pressed). Instead, the warning application 131A-2 just pops-up a message warning the user of some event (e.g., such as a fire in the building).

The context document 122A may define each application 131A-1 and 131A-2 to have different URL fields 214. This way each application 131A-1 and 131A-2 can make changes (by making changes to their respective widget documents 132) to what widgets are displayed/played/vibrated without having to change the context document 122A. Alternatively, all the widgets for each application 131A-1 and 131A-2 may be defined in the context document 122A.

The widget field 251 may include different fields and/or additional fields depending upon the type of widget being defined by the application 131. For example, the widget field 251 may have additional fields that further define the button, such as a text for the button, a size field to define dimensions of the button, an icon for the button, and/or the like. The type may vary based on the particular widget for the application 131. For example, the type may be a menu, an icon, a graphic, a menu, a picture, a menu bar, a combination of these (e.g., a menu bar with a menu), and the like.

The attachment point may be based on activation of a displayed device object, such as a voice call window (e.g., attaching a button to the voice call window), a video call window, a home screen, a contact or list of contacts, a call log, a menu (i.e., inserting a new menu item into a menu), a feature list, an instant message window, an email window, a button, an image, a text field, a tab, a panel, and/or the like.

The scope for displaying/playing/vibrating the widget may be defined based on various types of parameters. For example, the scope may be based on detecting a phrase spoken in a communication session. In this example, the attachment point is a voice call window and the scope is detection of a word or phrase in the voice call. As a result, the widget (e.g., a button) is attached to the voice call window when the word or phrase is detected in the voice call. For example, a call monitoring application 131 may detect the phrase and send a message to the widget management module 104 to enable a button that provides information on the phrase that was detected. Alternatively, the scope may be based on various kinds of events, such as detection of the user sending an email to a particular user, detection of an Instant Messaging session with a particular user, establishment of a video call, termination of a call, call forwarding, call forking, call conferencing, and/or the like.

Although not shown, the defined number of widgets for each application 131A-1 and 131A-2 may include any number of defined widgets. For example, the recording application 131A-1 may also include a text box for the user to enter a password to record the call. Similarly, more than two applications 131 may be defined. For example, the context document 122A/widget document 132A may define a third application 131, such as a call forwarding application 131.

In addition, the context document 122A or the widget document 132A may define sound widgets. A sound widget may have an attachment point and scope like a graphical widget. For example, the sound widget may have an attachment point to a particular window and scope of when the window is closed (the sound is played when the particular window is closed). The widget field 251 may define a sound that is played when a graphical widget comes within scope and is displayed, such as a beep, ring tone, song and/or the like. The type of sound may be defined in the widget field 251.

In addition, the context document 122 or the widget document 132 may define vibration widgets. A vibration widget may have an attachment point and scope like a graphical/sound widget. For example, a vibration widget may have an attachment point of a menu and a scope of when a menu item is selected. Thus, a vibrator in the communication device 101 will vibrate when the menu item is selected. The vibration widget may cause the vibrator to vibrate in a specific pattern based on the scope/attachment point.

FIG. 2B is a diagram of context document 122B and widget document 132B for a communication device 101. FIG. 2B is a second exemplary embodiment how the context document 122 and the widget document 132 may be defined. The context document 122B is shown with a tree structure that defines a base level 200B, a user-d definition 202B, an application definition 210B, and two applications 131: a recording application 131B-1 and a warning application 131B-2. The communication device 101 downloads the context document 122B to identify the applications (131B-1 and 131B-2 in this example) that will be supported in the communication device 101.

When the communication device 101 receives the context document 122B (as described in FIG. 3), the resource manager 102 parses the application definition 210B to identify the applications 131B-1 and 131B-2. In this example, the recording application 131B-1 and the warning application 131B-2 are defined differently to illustrate additional ways that the context document 122B/widget document 132B can be defined.

In this example, the recording application 131B-1 is the same recording application as defined in FIG. 2A. In this embodiment, the fields for the type, status, refresh, attachment point, scope, and url are defined in the context document 122B. The type, status, refresh, attachment point, and scope are all controlled by the recording application 131B-1.

The action field 260 for the recording application 131B-1 is defined in the widget document 132B. The status of the action field 260 is updated by the communication device 101. This way, the field(s) controlled by the recording application 131B-1 are in the context document 122B and the field(s) updated by the communication are in the widget document 132B.

Although FIGS. 2A and 2B shown two exemplary ways that the different context documents 122 and widget documents 132 may be defined, one of skill in the art would recognize that the context documents 122/widget documents 132 may be defined in various ways in order to control various types of widgets.

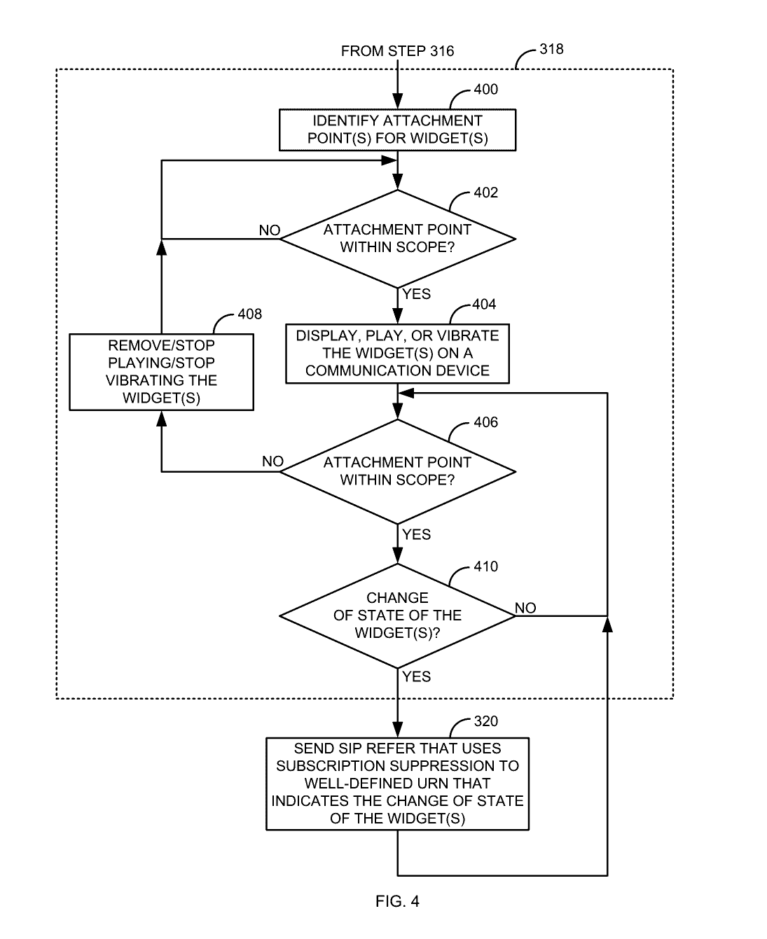

FIG. 3 is a flow diagram of a process for managing graphical user interface widgets on a communication device 101. Illustratively, the communication devices 101A-101N, the resource manager 102A, the download module 103A, the widget management module 104A, the user input 105A, the user output 106A, the network interface 107A, the server 120, the application server 130, and the applications 131 are stored-program-controlled entities, such as a computer or processor, which performs the method of FIGS. 3-4 and the processes described herein by executing program instructions stored in a non-transitory computer readable storage medium, such as a memory or disk. Although the methods described in FIGS. 3-4 are shown in a specific order, one of skill in the art would recognize that the steps in FIGS. 3-4 may be implemented in different orders and/or be implemented in a multi-threaded environment. Moreover, various steps may be omitted or added based on implementation.

The process starts in step 300 when the communication device 101A, via the resource manager 102A, sends a HTTP GET, to the server 120, to get a widget resource URI 121 for the application(s) 131 that will be supported by the communication device 101A. The widget resource URI 121 is a unique address for use by the communication device 101A. The widget resource URI 121 for the communication device 101A is typically different from the widget resource URI 121 for the communication device 101B or the communication device 101N. This allows each communication device 101 to support the same and/or different applications 131 based on their respective widget resource URI 121. Alternatively the widget resource URI may be based on a user. For example, the widget resource URI 121 may be based on a tree structure, such as /<base>/user/applications (as described in FIGS. 2A and 2B). This type of tree structure provides a unique widget resource URI 121 based on a specific user of the communication device 101A.

In response to sending the HPPT GET message in step 300, the server 120 sends, in step 302, the widget resource URI 121 to the resource manager 102A in a HTTP OK message. Using the widget resource URI 121, the resource manager 102A sends a SIP SUBSCRIBE message to the server 120 that includes the widget resource URI 121 in step 304. The server 120 sends, in step 306, a SIP NOTIFY message to the resource manager 102A that includes the context document 122 for the communication device 101A.

The SIP SUBSCRIBE of step 304 may be a SIP HTTP-monitor event for detecting changes in the context document 122. This allows the communication device 101A to monitor for any changes to the context document 122. If a change to the context document 122 occurs, the server 120 sends an updated context document 122 using a new SIP NOTIFY message.

Based on the URL field(s) 214 in the context document 122 received in step 306, the download module 103A sends, in step 308, a HTTP GET message to the URL for each application 131 (here only one HTTP GET is shown) to download the widget document 132 for each application 131. The widget document 132 is downloaded using the address(es) in the URL field(s) 214. In response to sending the HTTP GET message(s) in step 308, the application server 130 sends, in step 310, the widget document 132 in an HTTP OK message. Steps 308 and 310 may be repeated for each application 131 that has a corresponding widget document 132 using the defined URL field 214 for each widget document 132.

The steps 306 and 308 may be unnecessary if the context document includes the information regarding the widgets. For example, if each of the applications 131 were defined in the manner of the warning application as shown in widget field 251A-2 where the URL field is NULL.

Based on receiving the widget document(s) 132 in step 310, the widget management module 104 parses the widget document(s) 132 to identify each of the fields defined for the widgets for each of the applications 131 in step 312. In response, the widget management module 104 sends, to the application 131, a SIP subscribe for the HTTP-monitor events related to the widget in step 314. When an event associated with the widget is detected, the application 131 sends a SIP NOTIFY message in step 316 to notify the widget management module 104. The process of step 314 is completed for each widget in each application 131. This allows the application 131 to send updates for each widget using the SIP NOTIFY of step 316.

Based on the widget document(s) 132, the widget management module 104 determines the attributes and context for each widget in step 318, which eventually includes displaying the widget in the user output 106. The process of step 318 is described in further detail in FIG. 4. Upon detecting a change of state of the widget, the widget management module 104 sends the change of state of the widget to the application 131 in step 320. For example, if the user selects a menu, the selection of the menu is sent to the application 131.

In one embodiment, the application 131 can dynamically add widgets to a URI registry. For example, the application 131 can dynamically update the widget document 132. If the communication device 101 has sent a SIP subscribe to notified of the change of the widget document 132, the communication device 101 will be notified of the dynamic update of the widget document 132.

FIG. 4 is a flow diagram of a process for determining an attachment point for a scope of a graphical user interface widget. The process of FIG. 4 is an exemplary embodiment of steps 318 and 320 of FIG. 3.

After receiving the SIP NOTIFY message in step 316, the widget management module 104 identifies an attachment point(s) for the widget(s) in step 400. The widget management module 104 identifies the attachment point(s) based on the context document 122 and/or widget document 132 as described in FIGS. 2A or 2B. The widget management module 104 determines if the attachment point is within a scope in step 402. If the attachment point is not within the scope in step 402, the process goes back to step 402.

Otherwise, if the attachment point is within the scope in step 402, the widget management module 104 renders the graphical widget(s) and the graphical widgets are displayed (graphical widgets), played (sound widgets) or vibrated (vibration widgets) on the communication device 101 in step 404. The widget management module 104 determines if the attachment point is within scope in step 406. If the attachment point is no longer within scope in step 406, the widget management module 104 removes (graphical widgets), stops playing (sound widgets), and/or stops vibrating (vibration widgets) the widget in the user output 106 in step 408 and the process goes back to step 402.

Otherwise, if the attachment point is within scope in step 406, the widget management module 104 determines if there is a change of state of the widget(s). For example, a change of state may be a button push, a selection of a menu, entering of text within a text box, movement of a cursor over an object, resizing a window, moving the widget, selection of a menu bar, and/or the like. If a change of state has not been detected in step 410, the process goes back to step 406.

Otherwise, if a change of state has been detected in step 410, the widget management module 104 sends a SIP REFER message that uses subscription suppression to a well defined Uniform Resource Name (URN) that indicates the change of state of the widget in step 320. For example, the SIP refer may change the state of the action field 260 to “start” when a user presses the recording application 131B1 described in FIG. 2A. The process then goes to step 406. In one embodiment, the use of SIP may be accomplished using HTTP based messaging. For example, the use of an HTTP POST may be used instead of using an SIP REFER message.

To illustrate, consider the following example using an enhanced call recording application 131. In this example, the call recording application 131 has two widgets: 1) a recording button (like previously described) and a pop-up window with two buttons. The recording button has the same widget field 251B-2 as shown in FIG. 2B. In addition, widget document 132B for the recording application 131B-1 includes a widget field 251 for the pop-up window that has a type of window, a window size, a text field (“caller xxx has dropped from the call, do you want to continue recording?”), a first button field (yes), a second button field (no), an attachment point of home, and a scope of conference caller drops. The widget field 251 for the pop-up window is structured similar to the structure for the widget field 251-B-2 with a corresponding URL field 214 for actions associated with the pop-up window.

The resource manager 102 sends the HPPT GET to get the widget resource URI 121 in step 300. The server 120 responds by sending the HTTP OK with the widget resource URI 121 in step 302. The download module 103 downloads the context document 122 in steps 304 and 306. The download module 103 downloads the widget document 132 for the recording application 131 in steps 308 and 310. The widget management module 104 parses the widget document 132 in step 312 to identify the recording button and the pop-up window.

In response to determining that there is are two widgets (call recording button and the pop-up window) for the call recording application 131, the widget management module 104 sends two SIP SUBSCRIBE messages (step 314) to be notified of any events associated with the call recording button and the pop-up window. The SIP SUBSCRIBE message includes the url 214 for each widget. The widget management module 104 identifies that the recording button has an attachment point to the home screen of the communication device 101 in step 400.

From the home window of the communication device 101, the user (Jim) makes a call to a conferencing bridge that sets up a conference call to three users, Jack, Sally, and Jane. In response setting up the conference call, the widget management module 104 determines that the attachment point of the recording button (call) is within scope in step 402. The recording button is displayed on the user output 106 in step 404 to Jim.

Jim selects the recording button to record the conference call. In response to Jim selecting the recording button, the widget management module 104 determines that there was a change of state of the recording button (Jim selecting the recording button) in step 410. The widget management module 104 sends the SIP REFER message of step 320 to the recording application 131 (to /<base>/users/widgets/recording/action). The recording application has also sent a SIP SUBSCRIBE to be notified of any changes of state to the widget. In response, the recording application 131 is notified (via a SIP NOTIFY) of the change of state of the recording button and starts to record the conference call between Jim, Jack, Sally, and Jane.

Sally drops from the conference call. The recording application 131 detects that Sally has dropped from the conference call. In response, the recording application 131 sends the SIP NOTIFY message of step 316 indicating that Sally has dropped from the conference call. The widget management module 104 determines in step 402 that the attachment point for the pop-up window is within scope (conference caller drops). The pop-up window is displayed in the user output 106 over the home screen (the attachment point for the pop-up window). The pop-up window states that Sally has dropped from the conference call and asks Jim if he wants to continue recording the conference call. Jim selects the no button on the pop-up window. The attachment point is no longer in scope for the pop-up window in step 406 and the pop-window is closed. The widget management module 104 sends the widget state of Jim selecting the no button. The recording application is notified (because the call recording application 131 has subscribed to be notified of events for the pop-up window). In response, the call recording application 131 stops recording the conference call and a recording of the conference call up to where Sally dropped from the conference call is sent to Jim's email.

In this example, the communication device 101 is unaware of semantics of the application 131. All the communication device 101 is aware of is that the widgets (the recording button and the pop-up window are displayed to a user and input is received from the user that is then conveyed to the recording application 131. The advantage to this approach is that the complexities of the recording application 131 can be developed separately without increasing the complexity of software in the communication device 101.

The above process are described using SIP and HTTP. However, in other embodiments, protocols such as proprietary protocols over WebSockets, SOAP, and/or the like may be used.

Of course, various changes and modifications to the illustrative embodiment described above will be apparent to those skilled in the art. These changes and modifications can be made without departing from the spirit and the scope of the system and method and without diminishing its attendant advantages. The following claims specify the scope of the invention. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
getting a widget resource Uniform Resource Identifier (URI) for a communication device, wherein the widget resource URI is located in a network; and
in response to getting the widget resource URI for the communication device, the communication device downloading a context document from the widget resource URI, wherein the context document defines a widget or a location of a widget document that defines the widget, for use in the communication device, and wherein the widget communicates with a corresponding network application.

2. The method of claim 1, further comprising:
identifying an attachment point for the widget, wherein the attachment point for the widget is associated with an activation of a device object;
determining that the attachment point is within a scope; and
in response to determining that attachment point is within the scope, displaying the widget on the communication device.

3. The method of claim 1, wherein the attachment point is at least one of the following: a voice call, a video call, a home screen, a contact, a call log, a menu, a feature list, an instant message, and an email.

4. The method of claim 1, further comprising sending a state of the widget to the network application.

5. The method of claim 1, wherein the communication device is unaware of semantics of the network application.

6. The method of claim 1, wherein the context document has a resource tree that defines a plurality of network applications that use a plurality of widgets.

7. The method of claim 6, wherein the resource tree identifies a location of a widget document for each of the plurality of network applications.

8. The method of claim 7 wherein the widget document identifies an address to a get the widget.

9. The method of claim 8, wherein the widget document is fetched from a Hyper Text Transport Protocol (HTTP) server at the address using a HTTP GET or by using WebSockets.

10. The method of claim 1, further comprising:
monitoring the widget resource URI using a SIP http-monitor event for a change in the context document; and
receiving a SIP notify message that includes an updated context document.

11. The method of claim 1, wherein the corresponding network application can dynamically register the widget in a URI registry.

12. The method of claim 1, wherein the widget is one of a graphical widget, a sound widget, and a vibration widget.

13. A communication device comprising:
a resource manager that gets a widget resource Uniform Resource Identifier (URI) for the communication device, wherein the widget resource URI is located in a network; and
a download module that downloads a context document from the widget resource URI in response to getting the widget resource URI for the communication device, wherein the context document defines a widget or a location of a widget document that defines the widget, for use in the communication device, and wherein the widget communicates with a corresponding network application.

14. The communication device of claim 13, further comprising a widget management module that identifies an attachment point for the widget, wherein the attachment point for the widget is associated with an activation of a device object, determines that the attachment point is within a scope, and displays the widget on the communication device in response to determining that attachment point is within the scope.

15. The communication device of claim 13, wherein the widget management module sends a state of the widget to the network application.

16. The communication device of claim 13, wherein the communication device is unaware of semantics of the network application.

17. The communication device of claim 13, wherein the context document has a resource tree that defines a plurality of network applications that use a plurality of widgets.

18. The communication device of claim 18, wherein the resource tree identifies a location of a widget document for each of the plurality of network applications and wherein the widget document identifies an address to a get the widget.

19. The communication device of claim 13, wherein:
the resource module monitors the widget resource URI using a SIP http-monitor event for a change in the context document and receiving a SIP notify message that includes an updated context document.

20. A non-transitory computer readable medium having stored thereon instructions that, when executed, cause a processor to perform a method, the instructions comprising:
instructions to get a widget resource Uniform Resource Identifier (URI) for a communication device, wherein the widget resource URI is located in a network; and
in response to getting the widget resource URI for the communication device, instructions to download a context document from the widget resource URI, wherein the context document defines a widget or a location of a widget document that defines the widget, for use in the communication device, and wherein the widget communicates with a corresponding network application.
